(19) United States
(12) Patent Application Publication
(10) Pub. No.: US 2012/0084217 A1
(43) Pub. Date: Apr. 5, 2012

(54) SYSTEM AND METHOD FOR RESPONDING TO CHANGING CONDITIONS IN CONTACT CENTERS

(75) Inventors: Joylee E. Kohler, Northglenn, CO (US); Michael Palmquist, Oakland, CA (US)

(73) Assignee: Avaya Inc., Basking Ridge, NJ (US)

(21) Appl. No.: 12/894,554

(22) Filed: Sep. 30, 2010

(51) Int. Cl. G06Q 10/00

(52) U.S. Cl. 705/304

(57) ABSTRACT

Embodiments of the present invention relate to a business continuity system and method where conditional profiles and processes can be set for multiple contact centers with a set of object types while each contact center object is capable of responding uniquely to a changed condition. In accordance with one embodiment, there is provided a contact center management system for managing conditions in a contact center, the system comprising a computer system database for storing conditional profiles, each conditional profile corresponding to a set of varying types of objects associated with a contact center; a condition monitoring unit for receiving condition notifications from the contact center; and a response unit for responding to a received condition notification with a corresponding conditional profile having the set of objects associated with that conditional profile, wherein multiple object types in the set of objects are capable of uniquely responding to the received condition.

### BACKGROUND OF THE INVENTION

1. Field of the Invention

Embodiments of the present invention generally relate to contact center architecture. More specifically, embodiments of the present invention relate to a system and method for responding to changing conditions within contact centers by changing object profiles and processes in order to substantially maintain business continuity.

2. Description of Related Art

Customer support needs and conditions in contact centers change all the time. In order to maintain business continuity within the contact centers while these changes in conditions are occurring at one or more contact centers, adjustments need to be made to certain contact center objects such as, but not limited to, routing and selection processes, routing points, agent assignments, agent scripting and processing, self-service, and the like, (collectively hereinafter referred to as “contact center objects”).

Currently, there are no known systems and methods for effectively reacting, in one fell swoop, automatically or in a consolidated manner, to such conditional changes, in order to adjust or modify certain contact center objects and maintain customer satisfaction.

At present, known processes for attempting to ensure business continuity by handling contact center conditional changes may consist of bulk, non-tailored agent reassignment, creating backup vectors and/or moving vector directory numbers (“VDN's”) to the backup. However, these changes are only effective for a single object or for objects that are of one given type.

Other less than desirable workaround systems and methods include having a supervisor log into an ad hoc skill to indicate to a vector that a change in condition in one or more contact centers to one or more objects is occurring. Then, each and every routing process has to be programmed to determine if any agent is staffed to that ad hoc skill.

However, at least one disadvantage of these known methods of addressing conditional changes at contact centers is that all contact center objects of a given type are directed to provide the same treatment for a given condition, even though a client or customer would be better served by having each contact center object respond uniquely to a given condition. Also, other known solutions support backups for a single contact center object type. At a minimum, a separate action is required for each contact center object type, which is also a disadvantage with these known methods.

Thus, there is a need for an improved business continuity system and method where, as a result of a changed condition in at least one contact center, in a substantially single action, profiles and processes can be changed for multiple contact center object types, while each contact center object is capable of responding uniquely to the changed condition.

### SUMMARY

Embodiments of the present invention relate to a system and method for responding to changing conditions within contact centers by changing object profiles and processes. In one embodiment, there is provided a contact center management system for managing conditions in a contact center, the system comprising a computer system database for storing conditional profiles, each conditional profile corresponding to a set of varying types of objects associated with a contact center; a condition monitoring unit for receiving condition notifications from the contact center; and a response unit for responding to a received condition notification with a corresponding conditional profile having the set of objects associated with that conditional profile, wherein multiple object types in the set of objects are capable of uniquely responding to the received condition of the contact center.

The response unit may comprise a qualification unit for qualifying an appropriate response based upon the received condition from the condition monitoring unit. The qualification unit may, by way of example, qualify responses based upon end customer value and agent profiles and may determine the severity of a received condition notification and direct a response with the appropriate conditional profile.

In accordance with another embodiment, there is provided a method for managing conditions in a contact center, comprising providing a contact center management system having a computer system database of conditional profiles, each conditional profile having a set of different types of contact center objects associated therewith; receiving a condition notification from the contact center; and responding with a conditional profile such that the contact center objects associated with that conditional profile respond appropriately to the condition of the contact center.

The method may also comprise a condition monitoring step for monitoring and detecting a condition, wherein the condition may be detected automatically based upon current status of objects or by an administratively set condition determined by a manager.

In accordance with another embodiment, there is provided a system for managing conditions in a contact center, comprising a network management server, accessible via a computer network, comprising a computer readable medium comprising program instructions, wherein the program instructions are computer-executable to implement providing a database of conditional profiles, each conditional profile having a set of different types of contact center objects; receiving a condition notification from the contact center; and responding with a conditional profile such that the contact center objects associated with that conditional profile respond accordingly to the condition of the contact center.

### BRIEF DESCRIPTION OF THE DRAWINGS

So the manner in which above recited features of the present invention can be understood in detail, a more particular description of embodiments of the present invention, briefly summarized above, may be had by reference to embodiments, several of which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 is a block diagram depicting a network architecture of a contact center network in accordance with an embodiment of the present invention;

FIG. 2 is a block diagram depicting the main components of a contact center in accordance with an embodiment of the invention;

FIG. 3 is a block diagram depicting a general computer system, which is capable of being used in connection with the contact center network depicted in FIG. 1 in accordance with an embodiment of the present invention; and

FIG. 4 is a flow chart illustrating a method involved in reacting to changed conditions in a contact center in accordance with another embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

Embodiments of the present invention relate to a business continuity system and method where, as a result of a changed condition in at least one contact center, in a substantially single action, profiles and processes can be changed for multiple contact center object types while each contact center object is capable of responding uniquely to the changed condition.

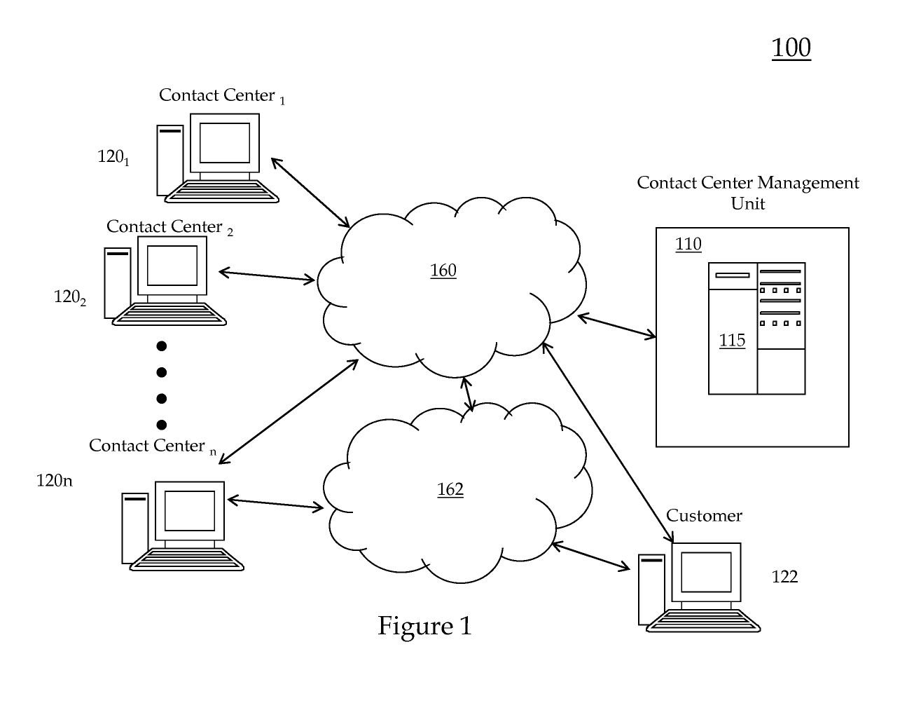

FIG. 1 shows a contact center network architecture 100 in accordance with an embodiment of the present invention. For example, there is provided a plurality of contact centers 120 (or call centers, the terms may be used interchangeably herein), namely 120₁, 120₂, 120n, which may be connected to the public switched telephone network (PSTN) 162, either directly or by way of a global computer network, such as the Internet 160.

Any contact center can be accessed by a customer 122 using a telephone, cellular telephone, computer or any other telecommunication device to dial a telephone number or use any other means of communicating to contact a contact center. In general, the customer 122 will contact the particular contact center for which contact details are most readily available, or the contact center that is closest geographically (to minimize call or telecommunication charges).

The contact centers 120₁ to 120n may be part of the same overall enterprise (e.g., being dedicated contact centers in different geographical sites belonging to a single company), or some or all of them may be independent from one another. To illustrate embodiments of the present invention, it may be assumed that the customer 122 wishes to receive some form of technical support from a company and that contact center 120₁is the one contact center run by that company. All of the other contact centers, in this given scenario, are independent from contact center 120₁ and from one another. Accordingly, when the customer 122 seeks technical support, contact center 120₁ will be contacted and respond to the customer 122. As understood by embodiments of the present invention, a customer may include any person, business or entity, or capable of participating in the system and methods disclosed herein.

Each contact center is also connected to the Internet 160 (or to some other local or wide area data network). Finally, FIG. 1 shows a contact center management server unit 110, the function of which will be further described in detail below. The unit 110 unit, including at least one tangible computer server 115, may also be connected to the Internet 160.

The contact center management unit 110 is shown in FIG. 1 as being a distinct entity from each contact center, but in practice, may be located in and run by one or more of the contact centers 120. The network management unit 110 may be connected to contact centers 120 directly or via a telecommunication network, which may comprise any network suitable for embodiments of the present invention.

For example, the network may be a partial or full deployment of most any communication/computer network or link, including any of, any multiple of, any combination of or any combination of multiples of a public or private, terrestrial wireless or satellite, and wireline networks or links. The network may include, for example, network elements from a PSTN 162, the Internet 160, core and proprietary public networks, wireless voice and packet-data networks, such as 1G, 2G, 2.5G, 3G and 4G telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

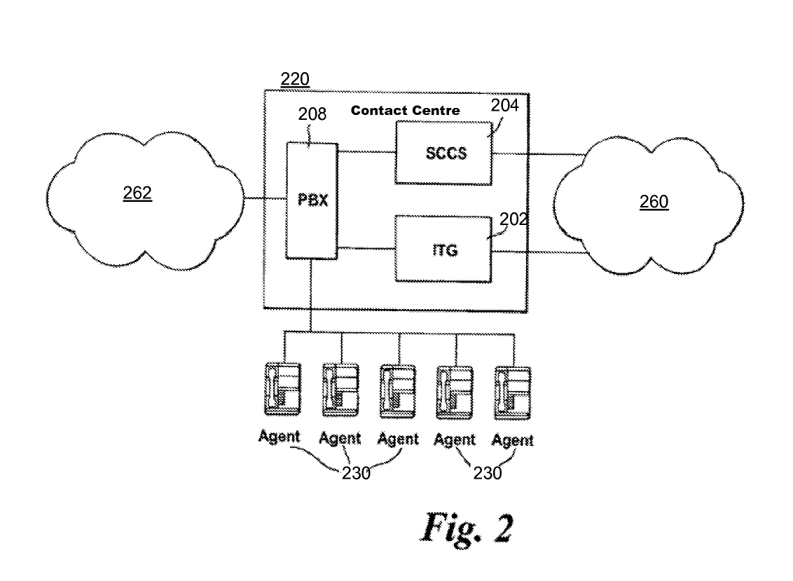

As illustrated in FIG. 2, each contact center 220 includes a private branch exchange (PBX) 208 which is connected to the PSTN 262 to receive and handle calls in a known manner. A plurality of agents 230 are connected to the PBX 208 to deal with customer calls (or contacts of other media types). A suitable PBX is the Meridian exchange from Nortel Networks, which is familiar to a person of ordinary skill in the art.

An internet telephony gateway (ITG) 202 connects the PBX 208 to the Internet 260, allowing the PBX to receive VoIP (voice over internet protocol) calls from the Internet, and allowing agents to make calls using VoIP technology.

A contact center server 220 (in this case, for example, the Symposium Call Center Server or SCCS) 204 is also integrated in the contact center. The SCCS 204 oversees and manages the running of the contact center 120, by instructing the PBX 208 to transfer calls to suitable agents based on skill sets (which may be determined by passing the call through an Interactive Voice Response (IVR) unit in the PBX 208), presenting agents with call information, managing agent queues, etc. Again, the conventional operation of the SCCS 204 and its interaction with the Meridian PBX is well known in the art. The SCCS 204 is also connected to the Internet 260, to allow communication with the network management unit 110 (FIG. 1).

The network management unit 110 (FIG. 1) enables a network of contact centers 120 to be dynamically created and managed, even where the contact centers are independent entities. Typically, an enterprise requiring dependable contact center functioning (e.g., to provide reliable customer support and business continuity) will manage its own network management unit. Thus, in the illustrated embodiment, the enterprise to which contact centers 120 belong will provide the network management unit 110 as an auxiliary component of contact centers 120. Network management unit 110 provides a point of contact on the Internet 160 to enable other contact centers having the requisite attributes to offer their services to contact centers 120. Contact centers 120 can then use these other contact centers as an overflow scenario.

Even where all of the contact centers 120₁₋ₙ, are part of the same enterprise, the network management unit 110 allows the various contact centers to cooperate better and to provide higher customer service levels and business continuity.

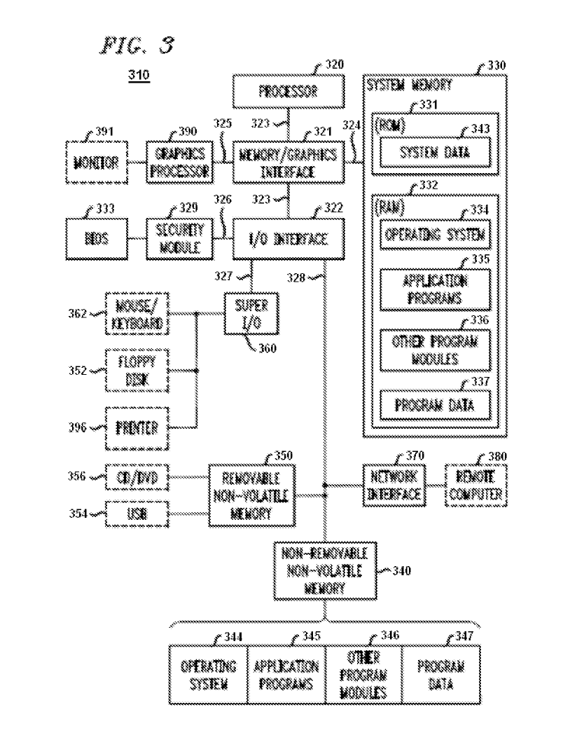

In accordance with one embodiment of the present invention, any of the contact centers 120 or contact center management server's server 115 may comprise a general purpose computer 310, for example, as shown in the form of a computer 310 depicted in FIG. 3. As appreciated by embodiments of the present invention, more practical devices, such as desktop computers, laptop computers, netbook computers, mobile handheld computers, mobile devices, mobile telephones, or the like, may likely to be utilized than a general computer 310 for embodiments of the present invention. However, it is also appreciated there is a significant similarly in core components between a mobile computing system and a general computer 310. Therefore, the following components are described for exemplary purposes, and each component's mobile or portable equivalent is also contemplated within embodiments of the present invention.

Components shown in dashed outline are not necessarily part of the computer 310, but are used to illustrate the exemplary embodiment of FIG. 3. Components of computer 310 may include, but are not limited to, a processor 320, a system memory 330, a memory/graphics interface 321, also known as a Northbridge chip, and an I/O interface 322, also known as a Southbridge chip. The system memory 330 and a graphics processor 390 may be coupled to the memory/graphics interface 321. A monitor 391 or other graphic output device may be coupled to the graphics processor 390.

A series of system busses may couple various system components including a high speed system bus 323 between the processor 320, the memory/graphics interface 321 and the I/O interface 322, a front-side bus 324 between the memory/graphics interface 321 and the system memory 330, and an advanced graphics processing (AGP) bus 325 between the memory/graphics interface 321 and the graphics processor 390. The system bus 323 may be any of several types of bus structures including, by way of example, and not limitation, such architectures include an Industry Standard Architecture (ISA) bus, a Micro Channel Architecture (MCA) bus and an Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium, which can be used to store the desired information, and which can accessed by computer 310.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Such communication media may be utilized to send and receive information and data between and among contact centers 120 and network management units 110.

The system memory 330 includes computer storage media in the form of volatile and/or nonvolatile memory such as read only memory (ROM) 331 and random access memory (RAM) 332. The system memory 330 may include a segmented portion for storing conditional profiles of sets of objects associated with respective conditional profiles. The system ROM 331 may contain permanent system data 343, such as contact center, agent and object identifying information. The system data 343 may be configured to include a relational database comprising means for qualifying conditional profiles having sets of object types. Such means include but are not limited to selection algorithms for selecting the appropriate conditional profile based upon a received condition notification.

In some embodiments, a basic input/output system (BIOS) may also be stored in system ROM 331. RAM 332 typically contains data and/or program modules that are immediately accessible to and/or presently being operated on by processor 320. By way of example, and not limitation, FIG. 3 illustrates operating system 334, application programs 335, other program modules 336, and program data 337.

The I/O interface 322 may couple the system bus 323 with a number of other busses 326, 327 and 328 that couple a variety of internal and external devices to the computer 310. A serial peripheral interface (SPI) bus 326 may connect to a basic input/output system (BIOS) memory 333 containing the basic routines that help to transfer information between elements within computer 310, such as during start-up.

In some embodiments, a security module 329 may be incorporated to manage metering, billing, and enforcement of policies. The security module 329 may comprise any known security technology suitable for embodiments disclosed herein.

A super input/output chip 360 may be used to connect to a number of “legacy” peripherals, such as floppy disk 352, keyboard/mouse 362, and printer 396, as examples. The super I/O chip 360 may be connected to the I/O interface 322 with a low pin count (LPC) bus, in some embodiments. The super I/O chip 360 is widely available in the commercial marketplace.

In one embodiment, bus 328 may be a Peripheral Component Interconnect (PCI) bus, or a variation thereof, may be used to connect higher speed peripherals to the I/O interface 322. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 428 may be an advanced technology attachment (ATA) bus, in the form of a serial ATA bus (SATA) or parallel ATA (PATA).

The computer 310 may also include other removable/non-removable, volatile/nonvolatile computer storage media. By way of example only, FIG. 3 illustrates a hard disk drive 340 that reads from or writes to non-removable, nonvolatile magnetic media. Removable media, such as a universal serial bus (USB) memory 354 or CD/DVD drive 356 may be connected to the PCI bus 328 directly or through an interface 350. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 3, provide storage of computer readable instructions, data structures, program modules and other data for the computer 310. In FIG. 3, for example, hard disk drive 340 is illustrated as storing operating system 344, application programs 345, other program modules 346, and program data 347. Note that these components can either be the same as or different from operating system 334, application programs 335, other program modules 336, and program data 337.

Operating system 344, application programs 345, other program modules 346, and program data 347 are given different numbers here to illustrate that, at a minimum, they are different copies. A user may enter commands and information into the computer 310 through input devices such as a mouse/keyboard 362 or other input device combination. Other input devices (not shown) may include a microphone, joystick, game pad, satellite dish, scanner, or the like. These and other input devices are often connected to the processor 320 through one of the I/O interface busses, such as the SPI 326, the LPC 327, or the PCI 328, but other busses may be used. In some embodiments, other devices may be coupled to parallel ports, infrared interfaces, game ports, and the like (not depicted), via the super I/O chip 360.

The computer 310 may operate in a networked environment using logical connections to one or more remote computers, such as a remote computer 380 via a network interface controller (NIC) 370. The remote computer 380 may be a personal computer, a server, a router, a network PC, a peer device, a contact center agent's or manager's computer, or other common network node, and typically includes many or all of the elements described above relative to the computer 310. The logical connection between the NIC 370 and the remote computer 380 depicted in FIG. 3 may include a local area network (LAN), a wide area network (WAN), or both, but may also include other networks. Such networking environments are commonplace in offices, contact centers, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 310 of FIG. 3 is described as an exemplary computing device for various applications of embodiments of the present invention, it should be appreciated, a multitude of similar computing devices exist and are equally suitable for embodiments of the present invention. It is further understood by embodiments of the present invention, a computing device may comprise all of the elements disclosed in FIG. 3, or any combination of one or more of such elements, in order to perform the necessary functions of the embodiments of the present invention.

It is understood by embodiments of the present invention that a computer, such as the one depicted in FIG. 3, may be connected to a computer network or system. A computer network includes the Internet, a global computer network, an internal computer network, dedicated server networks, and the like.

Thus, a contact center management system for managing conditions in one or more contact centers may utilize the contact center management unit 110 and server 115 to achieve business continuity. The application programs 345 of the general purpose computer 310, as described in FIG. 3, may include an interface with a computer system database and control storing and accessing the conditional profiles. The applications programs 345 may also utilize the communication media element and control a condition monitoring unit for monitoring contact center conditions and receiving condition notifications from the contact center(s), either automatically or from a contact center manager. The applications programs 345 may control responding to a received condition notification with a corresponding or qualified conditional profile. Such profile containing the set of objects associated with the set profile, which objects are the ones that respond to the condition.

In operation, embodiments of the present invention provide the ability to create conditional profiles for contact center objects. These profiles can be automatically triggered or manually activated based a condition, for example, but not limited to, understaffed, overstaffed, service contract in jeopardy, weather event, emergency event, business event, security event, out of hours, etc. An embodiment of the present invention comprises providing a single name or set to different types of objects so that when that particular condition occurs, all objects with the named conditional profile respond accordingly.

In accordance with an embodiment of the present invention, there is provided a method for managing conditions in a contact center, which may be implemented using a contact center management system as described in connection with FIGS. 1-3 above.

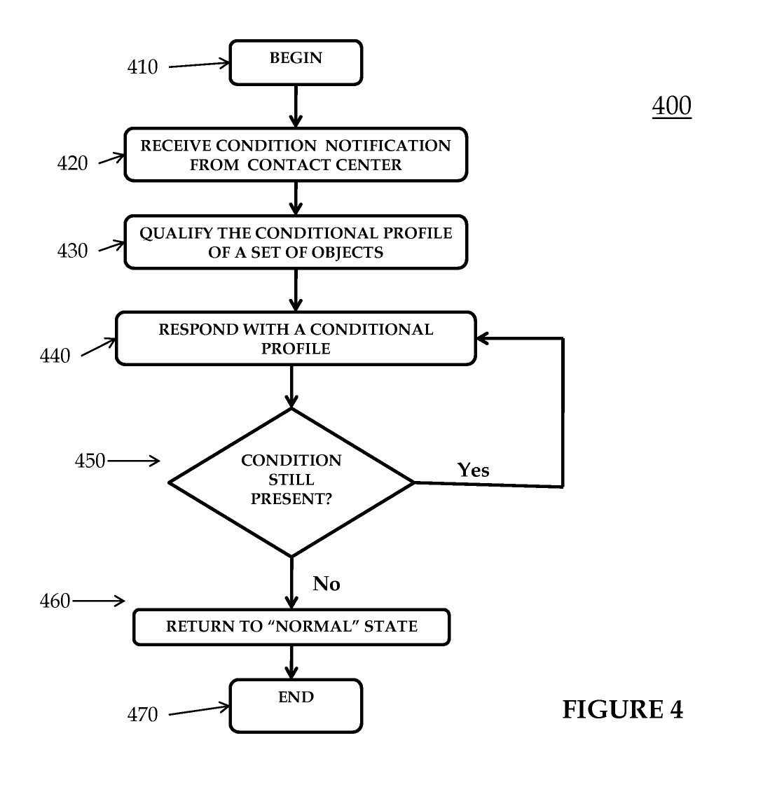

As an example, referring to FIG. 4, to prepare for an understaffed condition, for example, the method begins at step 410. At step 420, the contact management system may receive a condition notification from a contact center that there is an understaffed condition in that contact center. The contact center can represent one or more contact centers grouped as a result of one or more criteria, as used in this example, due to an understaffed condition. However, one or more contact centers can be grouped due to other conditions and or a combination of one or more different conditions.

This understaffed condition might be detected automatically based on agent occupancy or something a manager decides and administratively sets the condition to, for example, ‘understaffed’. To set it up routing points (VDNs), in this example, separate profiles of sets of objects named ‘understaffed’ would be set. The ‘understaffed’ profiles points to different processes (vector) for identifying and qualifying a customer. Each routing point profile may point to its own process (vector) with different treatment given during the ‘understaffed’ condition. Other contact center objects may be adjusted or changed as well. Such contact center objects include but are not limited to routing and selection processes, routing points, agent assignments, agent scripting and processing, self-service, and the like, (collectively hereinafter referred to as “contact center objects”).

At step 430, there is a qualifying step for qualifying the appropriate conditional profile of a set of objects for responding to the condition notification in a tailored manner. In the qualification process, for example, it may be desired to send more end customers to self service or an outsourcer based on end customer value when the condition being received is ‘understaffed’. Alternatively, it may be desired in this particular example, to have fewer restrictions on what agent qualities are required. Furthermore, it may be desired to inform end customers of longer wait times. The qualification process may also check for a condition or the severity of a condition and take different actions based on the response.

In another embodiment of the present invention, a qualification step may comprise selection algorithms (ACD), which can also have named profiles. The ‘understaffed’ profile, for example, could ignore proficiency levels and profitability and focus on maximizing efficiency. In some implementations the selection process may choose self-service or assisted service agents.

At step 440, a response is sent to the contact center or centers having the ‘understaffed condition’ wherein the response includes the conditional profile such that all contact center objects associated with that particular conditional profile respond appropriately to the condition. Whenever the ‘understaffed’ condition is received, all objects tagged with an ‘understaffed’ profile automatically have the new profile applied to the next contact or client arriving at this object, thus preserving business continuity.

At step 450, in this example, the understaffed condition is checked to determine if such a condition is still present in the one or more contact centers. If “yes”, then the conditional profile remains active and the set of contact center objects continue to respond accordingly and appropriately. In this example, while the ‘understaffed’ condition is still present, the previously tagged objects are still functioning under the same ‘understaffed’ profile. If, on the other hand, the condition is no longer present, then the contact center or centers return to “normal” state, mode or operation at step 460. In this regard, all objects are directed back or reset to return to their usually operation mode(s). The process ends at 470 and business continuity has been substantially maintained.

As an alternative embodiment, the ‘normal’ state, mode or operation may be a conditional event in and of itself. Thus, while the system may be resolving a previously received condition notification, e.g., ‘understaffed’, it may then receive a next condition notification of ‘normal.’ In other words, either automatically or by way of the contact center manager sending a condition notification, the system may receive an “all clear” condition, which will reset all objects back to their normal states or operations. Accordingly, this embodiment then would eliminate the need for steps 450 and 460 depicted in FIG. 4. Instead, once a ‘normal’ condition notification is received, the system returns to status quo without the need to inquire if condition is still present. Alternatively, the ‘normal’ condition or state may be treated like any other condition and follow the same steps as depicted in FIG. 4.

As contemplated by embodiments of the present invention, during the time in which the conditional profile of objects is active in response to a condition notification at the contact center(s), using the understaffed condition example above, one advantage of embodiments of the present invention is that agent assignment profiles might vary by agent. That is, for some agents, it is better to reduce their assignments and let them focus on a single type of contact. For other agents, however, it would be more desirable to increase their assignments to let them help wherever needed. Assignments include, but are not limited to, skills or qualities, proficiencies, and preferences.

While the ‘understaffed’ condition(s) exist, assisted and self service scripts may have to be changed as well. Agent scripts, for example, would be stream-lined to maximize throughput. The scripts may also check for a condition or the severity of a condition and take different actions based on the response. Finally, there may be entities and processes that do not have an ‘understaffed’ profile. In which case, they ignore any changes to the ‘understaffed’ condition.

As an alternative embodiment to the steps described in connection with FIG. 4, a detection step may be included prior to, or simultaneous with, the receiving step. That is, instead of a condition notification being pushed to the contact center management unit 110, the server 115 or general purpose computer 310 within the overall contact center architecture may be configured to check and detect contact center conditional changes that may rise to a threshold where it is more likely than not that business continuity at the one or more contact centers will be interrupted should adjustments not be made. This detection step may be automatic or it may be assisted by a contact center manager, whereby the manager determines a condition such as understaffed and sets an alert using an input device such as a desktop, laptop or handheld computing device. That alert becomes the condition notification that is then received by the contact center management unit 110 and processed according the embodiments of the present invention hereinabove described.

One of many advantages of embodiments of the present invention includes a conditional profile, which may be identified by a single name or other identifying indicia, and which is capable of identifying a given condition and that same conditional profile can be assigned to, or associated with, a set of contact center objects of different types. The condition can be automatically detected and applied, or can manually be applied with a single action to some or all of the contact center objects. Each contact center object, being of one or more types, can respond differently or the same to a given condition.

By making it relatively easy to activate, contact center managers can use hand-held devices while away from their desks to change conditions. For example, should the facility housing the contact center be forced to evacuate due to a fire drill or other emergency, the contact center manager can activate a condition notification and have all contacts re-vectored on a temporary basis until the fire drill or emergency has ended and the contact center is back to “normal.” This ability to use a single action to apply changes to some or all contact center objects so they can respond the same or differently to a given condition is just one advantage over known methods. Embodiments of the present invention simplify the activation of plans and facilitate having multiple plans for different business conditions. These plans can be used to fine tune contact center operations to maximize value to the business. Users will appreciate the ability to prepare for an event or condition and take immediate action a condition notification is received.

While the foregoing is directed to embodiments of the present invention, other and further embodiments of the invention may be devised without departing from the basic scope thereof. It is understood that various embodiments described herein may be utilized in combination with any other embodiment described, without departing from the scope contained herein.

What is claimed is:

1. A contact center management system for managing conditions in a contact center, the system comprising:
a computer system database for storing conditional profiles, each conditional profile corresponding to a set of varying types of objects associated with a contact center;
a condition monitoring unit for receiving condition notifications from the contact center; and
a response unit for responding to a received condition notification with a corresponding conditional profile having the set of objects associated with that conditional profile, wherein multiple object types in the set of objects are capable of uniquely responding to the received condition of the contact center.

2. The system of claim 1, wherein the response unit comprises a qualification unit for qualifying an appropriate response based upon the received condition from the condition monitoring unit.

3. The system of claim 2, wherein the qualification unit qualifies responses based upon end customer value and agent profiles.

4. The system of claim 2, wherein the qualification unit determines the severity of a received condition notification and directs a response with the appropriate conditional profile.

5. The system of claim 4, wherein the qualification unit comprises a selection algorithm for selecting the appropriate conditional profile.

6. The system of claim 1, wherein the conditions are selected from a group consisting of understaffed, overstaffed, service contract in jeopardy, weather event, emergency event, business event, and out of hours conditions.

7. The system of claim 1, wherein the objects are selected from a group consisting of routing process, selection process, routing points, agent assignments, agent scripting and processing, and self service.

8. The system of claim 1, wherein each object from the set of objects in the conditional profile of the response from the response unit is capable of responding the same or differently to the received condition.

9. The system of claim 1, further comprising a transmission unit for remotely transmitting the response.

10. The system of claim 9, wherein the transmission unit is portable and is capable of being activated by a contact center manager to change conditions.

11. A method for managing conditions in a contact center, comprising:
providing a contact center management system comprising a computer system database of conditional profiles, each conditional profile having a set of different types of contact center objects associated therewith;
receiving a condition notification from the contact center; and
responding with a conditional profile such that the contact center objects associated with that conditional profile respond appropriately to the condition of the contact center.

12. The method of claim 11, further comprising a condition monitoring step for monitoring and detecting a condition.

13. The method of claim 12, wherein the condition is detected automatically based upon current status of objects.

14. The method of claim 12, wherein the condition is detected by an administratively set condition determined by a manager.

15. The method of claim 14, wherein the conditional profile information may be used by the contact center management system to determine the types of contact center objects that need to respond at the contact center to handle an end customer received at the contact center.

16. The method of claim 11, further comprising a qualification step for qualifying the appropriate conditional profile of a set of objects for responding to the condition notification.

17. The method of claim 16, wherein the qualification step comprises a selection algorithm for selecting the appropriate conditional profile.

18. The method of claim 17, wherein the selection algorithm of the qualification step determines the severity of a received condition notification and directs a response with the appropriate conditional profile.

19. The method of claim 11, wherein the responding step comprises providing modified assisted and self service scripts in association with the conditional profile.

20. A system for managing conditions in a contact center, comprising:
a network management server, accessible via a computer network, comprising a computer readable medium comprising program instructions, wherein the program instructions are computer-executable to implement:
providing a database of conditional profiles, each conditional profile having a set of different types of contact center objects;
receiving a condition notification from the contact center; and
responding with a conditional profile such that all contact center objects associated with that conditional profile respond accordingly to the condition of the contact center.

21. The system of claim 20, further comprising detection means for detecting a condition.

22. The system of claim 21, wherein the condition is detected automatically based upon current status of objects.

23. The system of claim 21, wherein the condition is detected by an administratively set condition determined by a manager.

24. The system of claim 23, wherein the conditional profile information may be used by the contact center management system to determine the types of contact center objects that need to respond at the contact center to handle an end customer received at the contact center.

25. The system of claim 20, further comprising qualification means for qualifying the appropriate conditional profile of a set of objects for responding to the condition notification.

26. The system of claim 25, wherein the qualification means comprises a selection algorithm for selecting the appropriate conditional profile.

27. The system of claim 26, wherein the selection algorithm of the qualification means determines the severity of a received condition notification and directs a response with the appropriate conditional profile.

28. The system of claim 20, wherein the responding step comprises providing modified assisted and self service scripts in association with the conditional profile.

29. The system of claim 1, wherein multiple object types in the set of objects of the conditional profile are activated and deactivated by responding to a single received condition from the contact center.

30. The method of claim 11, wherein multiple object types in the set of objects of the conditional profile are activated and deactivated by responding to a single received condition from the contact center.
